(19) United States
(12) Patent Application Publication
(10) Pub. No.: US 2006/0049938 A1
(43) Pub. Date: Mar. 9, 2006

(54) Warning unit

(75) Inventor: Paul Andrew Wilson, Essex (GB)

Correspondence Address: Edwin D Schindler, Five Hirsch Avenue, PO Box 966, Coram, NY, 11727-0966, US

(73) Assignee: Medico Industries Incorporated, Wilkes-Barre, PA (US)

(21) Appl. No.: 10/535,087

(22) PCT Filed: Nov. 14, 2003
(86) PCT No.: PCT/GB03/04979

§ 371 Date: Aug. 4, 2005

(30) Foreign Application Priority Data
Nov. 14, 2002 (GB) 0226687.2

(51) Int. Cl. G08B 13/00

(52) U.S. Cl. 340/541; 340/539.23

(57) ABSTRACT

A warning unit includes a housing for mounting to a wall with the housing containing a control unit. The warning unit further includes a proximity sensor, which is able to detect the approach of a person to cause the control unit to activate a sound emitting device, which preferably replays a verbal warning message.

The present invention relates to a warning unit arranged to give a warning to anyone approaching or entering an area to be protected.

There are various situations where, particularly for safety reasons for example, it is desirable to give a warning to any person approaching or entering a particular area.

We have now devised a warning unit which provides an effective warning to anyone approaching the area which it protects.

In accordance with the present invention, there is provided a warning unit mounted to a wall, or arranged to be mounted to a wall, the warning unit comprising a housing mounted to or for mounting to the wall, the housing containing a control unit and the warning unit having a proximity sensor for detecting the approach of any person to cause the control unit to energise a sound emitting device.

Preferably the control unit is arranged to replay a verbal message via the sound emitting device. Preferably the control unit stores a number of verbal messages and a selector is provided for determining which of these messages is used. Preferably the warning unit includes means enabling new messages to be recorded.

The warning unit may include a flashing light which is energised in response to the proximity sensor detecting the approach of any person.

Preferably the housing of the warning unit comprises a front cover which is locked in its closed position but can be unlocked and opened to gain access to a control panel of the unit. The verbal message to be replayed is selected via this control panel: also, the length of a “sleeping period” is selected via the control panel, i.e. the period following a replay of the message, before the proximity sensor is allowed to cause the next replay of the message.

Preferably screw-holes for mounting the housing to the wall are accessible only once the front cover of the housing is opened.

Preferably the warning unit is powered by a battery contained within its housing. This battery is either replaceable, or is rechargeable from mains.

Preferably the front cover is provided with a pair of slots into which the opposite edges of a warning or safety sign may be inserted, the arrangement being such that, when the front cover is closed, the sign is held in position.

An embodiment of the present invention will now be devised by way of example only and with reference to the accompanying drawings, in which:

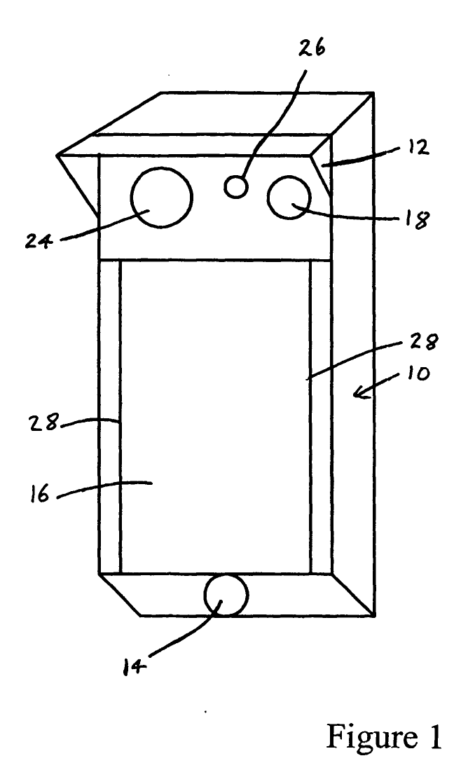

FIG. 1 is front view of a wall-mounted warning unit in accordance with the invention; and

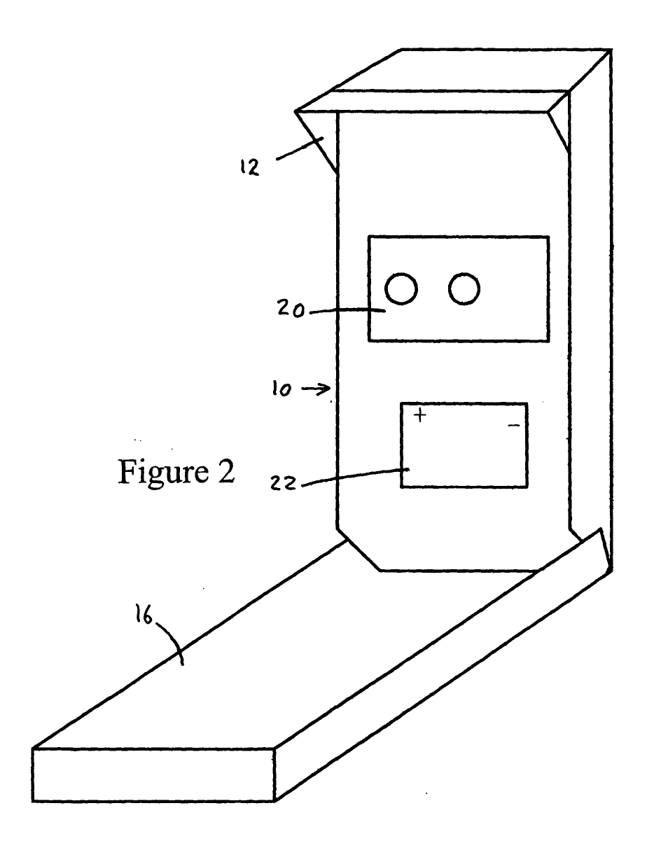

FIG. 2 is a similar view of the warning unit, shown with its front cover open.

Referring to the drawings, there is shown a wall-mounted warning unit which comprises a generally flat, rectangular housing 10 which is arranged to be mounted to a wall in an upright position. At its upper end, the housing 10 has a forwardly-projecting hood 12 to provide protection for the unit against rain. A proximity sensor 14 is mounted to the bottom end of the housing 10.

The housing 10 is provided with a front cover 16 which is hinged to the housing 10 along its bottom edge. A lock 18 serves to lock the front cover in its closed position. Within the housing 10, and behind the front cover 16, are mounted a control panel 20, a rechargeable battery 22, and an electronic control unit (not shown).

In use of the warning unit, should a person approach the area protected by the unit, the proximity sensor 14 activates the control unit to play a recorded audible message, which is relayed by a loudspeaker mounted behind a waterproof grille 24 in the front of the housing: a flashing light 26 is energised at the same time.

The control unit is arranged to store up to eight messages and the user can select, via the control panel, which message is to be replayed.

After each message-replay, there may be a delay (selectable, via the control panel), between zero seconds and one hour, for example) before the message will be replayed again (in response to a subsequent activation by the proximity sensor). In other words, the full cycle of operation is: detect, message playback, message delay, detect . . . and so on.

The back of the housing 10 is provided with screw-holes (accessible only when the front cover 16 is open) for mounting it to the wall. The unit is also provided with a movement sensor (not shown) arranged to provide an audible alarm in the event that the unit is moved by an unauthorised person: the audible alarm is preferably relayed through the same loudspeaker as the audible message.

The front cover 16 of the housing is formed with a pair of slots 28 into which the opposite edges of a 200 mm×150 mm safety sign my be inserted: the arrangement is such that when the front cover is closed and locked, the sign is retained in position and difficult to remove.

It will be appreciated that the warning unit which has been described may be mounted to a wall at a convenient height and will provide an effective warning to any approaching person, yet the warning unit will not obstruct the passage of authorised persons or vehicles.

One or more tapes or other elongate flexible elements may be provided, for linking between the warning unit and other structure, to form a barrier. For example, the warning unit may be mounted to the wall on one side of a lift and the tape or flexible element extended across the lift doors if the lift is out of order, the warning unit providing an audible warning message and the tape etc. providing a barrier. In particular, the warning unit may include one or more retractable tape units from which the tapes may be extended when required.

1-10. (canceled)

11. A warning unit mountable to a wall, comprising:
a housing mountable to a wall;
a control unit contained within said housing and including means for emitting sound; and,
a proximity sensor for detecting an approaching person for activating said means for emitting sound of said control unit upon sensing the approaching person.

12. The warning unit mountable to a wall according to claim 11, wherein said means for emitting sound of said control unit includes means for storing a pre-recorded verbal message able to be replayed by said means for emitting sound.

13. The warning unit mountable to a wall according to claim 12, wherein said means for emitting sound includes means for storing a plurality of verbal messages, said means for emitting sound further includes means for selecting a message to be replayed from among said plurality of verbal messages stored.

14. The warning unit mountable to a wall according to claim 12, further comprising means for recording new verbal messages.

15. The warning unit mountable to a wall according to claim 11, further comprising a flashing light capable of being activated by said proximity sensor upon sensing the approaching person.

16. The warning unit mountable to a wall according to claim 11, wherein said housing comprises a front cover that is lockable in a closed position and openable in an open position for gaining access to a control panel for controlling said control unit.

17. The warning unit mountable to a wall according to claim 16, wherein said means for emitting sound includes means for storing a plurality of verbal messages, said means for emitting sound further includes means for selecting a message, via said control panel, to be replayed from among said plurality of verbal messages stored.

18. The warning unit mountable to a wall according to claim 16, wherein said housing includes screw holes for mounting said housing to a wall, said screw holes being accessible only when said front cover of said housing is open.

19. The warning unit mountable to a wall according to claim 16, wherein said front cover includes a pair of slots into which opposite edges of a warning sign are insertable with said front cover holding in a fixed position the warning sign when said front cover of said housing is closed.

20. The warning unit mountable to a wall according to claim 16, wherein said control panel includes means for setting a period of time duration, following a replay of a pre-recorded verbal message by said means for emitting sound, before said proximity sensor is capable of activating another replay of said pre-recorded verbal message.

21. The warning unit mountable to a wall according to claim 11, wherein said control unit includes means for setting a period of time duration, following a replay of a pre-recorded verbal message by said means for emitting sound, before said proximity sensor is capable of activating another replay of said pre-recorded verbal message.
